(19) United States
(12) Patent Application Publication
(10) Pub. No.: US 2002/0141696 A1
(43) Pub. Date: Oct. 3, 2002

(54) Passive fiber alignment using exterior surface absorption

(76) Inventor: Donald Bruns, San Diego, CA (US)

Correspondence Address: Gary L. Eastman, 520 West Ash Street, Suite 306, San Diego, CA, 92101, US

(21) Appl. No.: 09/834,732

(22) Filed: Apr. 13, 2001

Related U.S. Application Data
(60) Provisional application No. 60/273,463, filed on Mar. 5, 2001.

(51) Int. Cl. G02B 6/26; G02B 6/32; G02B 6/22

(52) U.S. Cl. 385/31; 385/33; 385/128

(57) ABSTRACT

A system and method for the passive alignment of a fiber using exterior surface absorption includes a fiber having a core, cladding and coating containing absorptive material. Absorptive material in the coating on the fiber expands and constricts depending on the amount of light that is exposed to the absorptive material. If a larger amount of light strikes one side of the fiber, that side of the fiber will constrict, and the areas that are not contacted by light will expand. This expansion and contraction process will continue until the position of the end of the fiber shifts a position where there is an equal amount of light on all sides of the end of the fiber. The use of absorptive material minimizes, or eliminates, the need for optical feedback and guarantees an accurate alignment of an optical fiber with an incoming light source, which is not offered by current fibers.

### RELATED APPLICATION

This application is a continuation in part of Provisional Application Serial No: 60/273,463 entitled “Passive Fiber Alignment Using Exterior Surface Absorption” filed Mar. 5, 2001.

### FIELD OF THE INVENTION

The present invention relates generally to optical fibers. More specifically, the present invention pertains to methods of aligning optical fibers. The present invention is particularly, though not exclusively, useful for aligning optical fibers with converging light beams by using fibers with outside surfaces composed of absorption material which aligns the fiber with the light beam.

### BACKGROUND OF THE INVENTION

Over the past several decades, the use of optical fibers, or fiber optics, to transmit information on a light beam have become increasingly popular. In fact, much of the information which is transmitted today is done over optical fibers. The difficulty of aligning a light beam into an optical fiber typically requires optical feedback to make position corrections in either the light beam or the fiber. In some cases, particularly where single-mode (SM) fiber is used, it is necessary to continually monitor the optical feedback in order to maintain a proper alignment of the light beam on the fiber.

Accordingly, it is an object of the present invention to provide a fiber capable of aligning itself so that its core aligns with the focal point of a light beam by incorporating an absorptive material into the outside surface of the flexible fiber.

### SUMMARY OF THE PRESENT INVENTION

In order to minimize or eliminate the need for optical feedback, the present invention utilizes the external surface of the fiber as a passive actuator to automatically center the fiber on an incoming light beam. Specifically, an absorptive material on the outside of the fiber to bend the fiber into alignment with the light beam. For example, a single light beam to be focused into a single-mode fiber can pass through a dual-focal length lens to create an actuator signal based on absorption on the outside of the fiber. Typically, the fiber core is concentric to the outside diameter within 0.5 microns; this concentricity is required for standard fiber optic connectors. By using the absorption of light on the outside surface of the fiber to align the fiber, the same level of accuracy may be achieved. Much like a sunflower bends its stalk according toward an incoming light source to optimize the light onto the flower, the fiber itself will change the position of its end in response to light striking the outside surface of the fiber.

A light beam entering a fiber is usually gaussian in profile, being generated by another fiber or from a laser. Thus, most of the light is concentrated in the center of the beam, which is to be focused with an input lens and carefully aligned to the fiber core. A small amount of the light found in the external area of the beam can be focused with a concentric alignment lens, made in the form of a Fresnel lens, for example, or using diffractive optics. This lens would focus a ring of light onto the side of the fiber, which has been coated with absorptive material. The material property would be such that it shrinks when exposed to light. If there is any deviation in the alignment of the light beam, the ring of light strikes the surface of the fiber and causes the fiber to bend in the direction of the excess light, repositioning the fiber to be concentric to the incoming light beam, and maximizing the light which is received into the fiber core. One key advantage of this invention is that only the incident light beam, such as an incoming communication beam, is required, and any active optical feedback is minimized or wholly eliminated.

### DESCRIPTION OF THE DRAWINGS

The novel features of this invention, as well as the invention itself, both as to its structure and its operation, will be best understood from the accompanying drawings, taken in conjunction with the accompanying description, in which like reference characters refer to similar parts, and in which:

FIG. 1 is a side view of a preferred embodiment of the present invention showing a properly positioned optical fiber in relation to a converging light beam which provides an optimum optical signal into the core of the fiber;

FIG. 2 is a side view of a preferred embodiment of the present invention showing an improperly positioned fiber receiving only a small portion of the incoming optical signal, and the alternative position, in which the optical fiber changes its position to center the converging beam into the center of the fiber's core;

FIG. 3 is cross-sectional view of a preferred embodiment of the present invention taken along line 3-3 of FIG. 2, and showing the relative placement and dimensions of the core, cladding and exterior coating of the optical fiber;

FIG. 4A is a side view of a preferred embodiment of the present invention showing an improperly aligned fiber in a larger converging beam; and

FIG. 4B is a side view of a preferred embodiment of the present invention showing the fiber's adjustment and balanced position to the larger converging beam.

### DETAILED DESCRIPTION

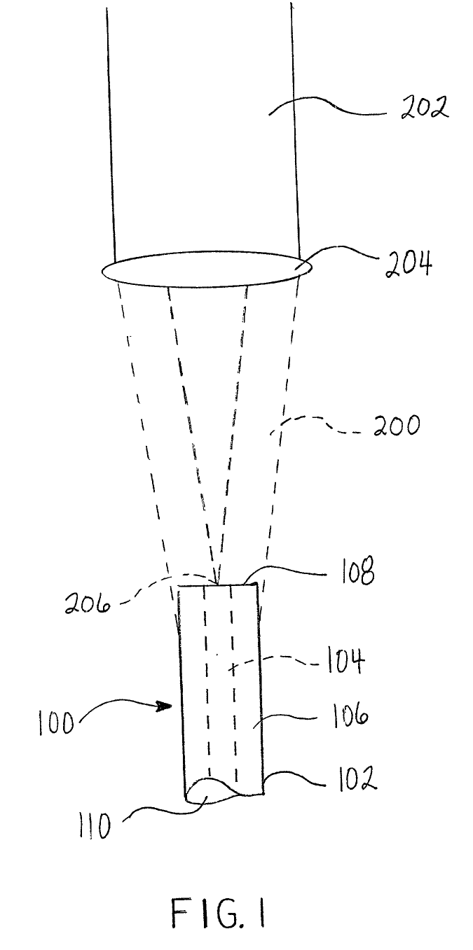

Referring initially to FIG. 1, a side view of the preferred embodiment of the Passive Fiber Alignment Using Exterior Surface Absorption of the present invention is shown and generally designated 100. In FIG. 1, fiber 100 is properly aligned with converging light beam 200 such that the beam focusses on the core of the fiber. More specifically, fiber 100 includes coating 102 surrounding core 104 and cladding 106, fiber end 108 and fiber shaft 110. The core 104 and cladding 106 are often called the body of the fiber 100.

Converging light beam 200 results from light beam 202 passing though focusing lens 204, which is shown as convex, for example. As converging beam 200 travels away from focusing lens 204, converging beam 200 becomes more concentrated into a smaller area until it reaches focal point 206. Focal point 206 of converging beam 200 strikes core 104 at fiber end 108 of a properly positioned fiber 100. When the focal point 206 is precisely positioned on fiber end 108, the light received into core 104 from light beam 202 is maximized.

Although a converging light beam 200 has been described in conjunction with the present invention, it is to be appreciated that no limitation on the present invention is intended. Rather, the present invention may be used to align an optical fiber with virtually any light source, including but not limited to converging, diverging, or collimated, light sources.

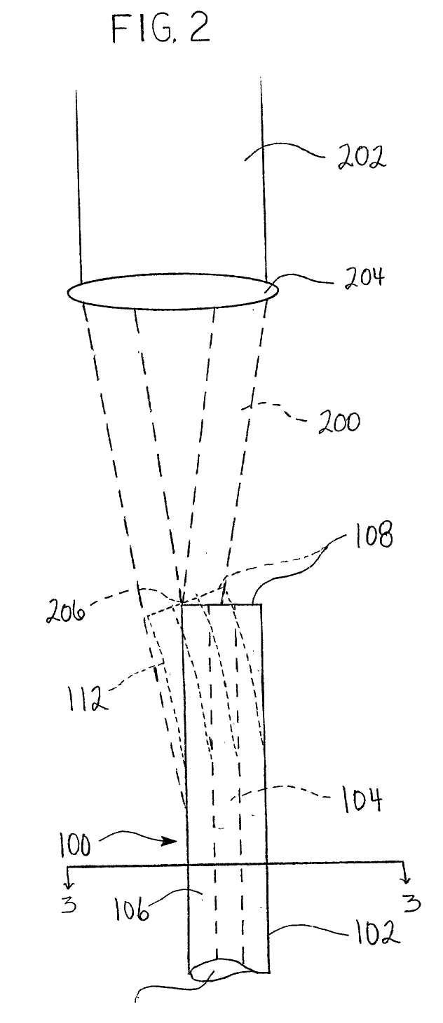

Turning now to FIG. 2, a side view of a preferred embodiment of the Passive Fiber Alignment Using Exterior Surface Absorption of the present invention is shown with an improper initial position of fiber 100 within converging beam 200. In this position, the converging beam 200 is not centered on the fiber 100, and results in a larger portion of the converging beam 200 striking the coating 102 on the outside surface of the fiber 100. Due to the converging beam 200 striking the outside surface of the fiber 100, fiber 100 changes its shape to an alternative position 112 (shown in dashed lines), which centers the core 104 of fiber 100 onto converging beam 200 to optimize the light received into the core 104.

As shown in FIG. 2, the initial position of fiber 100 does not allow light from converging beam 200 to contact core 104. Rather, the converging light beam 200 is focussed onto focal point 206 which is located near cladding 106 and thus a majority of the incoming light beam 200 strikes the coating 102 on the outside surface of fiber 100. Due to the improper position of fiber 100, the light entering core 104 at fiber end 108 and traveling through fiber shaft 110 is decreased significantly. Unfortunately, this type of misalignment is a common problem in optical systems using currently available fibers. Also, because the ambient temperature within optical equipment may fluctuate significantly, the alignment of the optical fibers may change due to the particular thermal characteristics of the fiber. As a result, the misalignment of the optical fibers presents a challenge to the manufacturing of high quality optical devices, such as optical switches, and presents a particular problem in applications where single mode (SM) fiber having a smaller core diameter is used.

In applications incorporating the present invention, coating 102 includes an absorptive material that expands and contracts depending on the quantity of light it receives. For example, the portion of coating 102 that receives a large amount of light constricts, while the portion that receives a smaller amount expands. The expanding and constricting of coating 102 on fiber 100 results in the movement of fiber 100 to alternative position 112 (shown in dashed lines). Coating 102 constricts where it is exposed to light, and expands where it is not exposed to light, until there is an equilibrium in coating 102, or equal amount of light on all portions of coating 102.

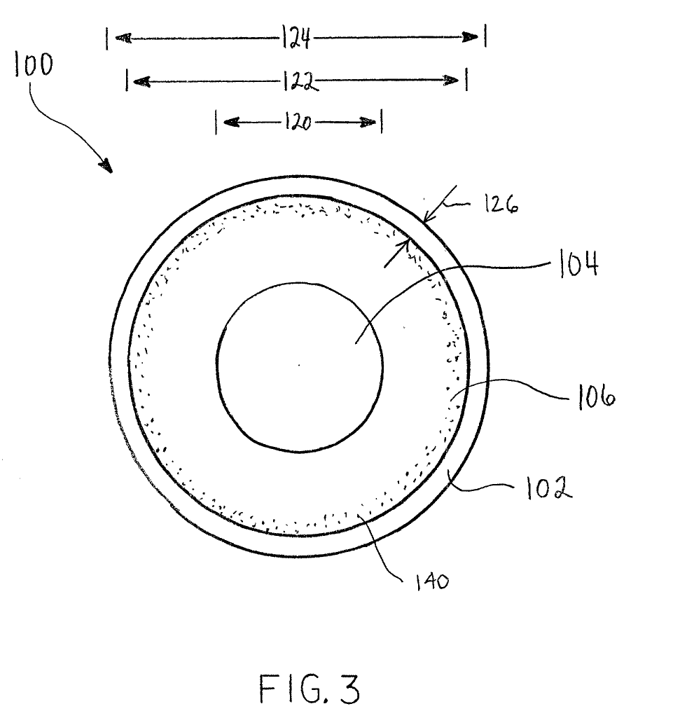

FIG. 3 is a cross-sectional view of a preferred embodiment of the Passive Fiber Alignment Using Exterior Surface Absorption 100 of the present invention as taken along line 3-3 of FIG. 2, and shows the relative diameters of coating 102, core 104 and cladding 106. As shown, core 104 has diameter 120, and is located in the center of fiber 100 and extends axially through fiber shaft 110 to fiber end 108. The diameter 120 of core 104 can vary, depending on the type of fiber being used. For example, for a single mode (SM) fiber, diameter 120 of core 104 is approximately eight to ten microns (8-10 μm), whereas a multi-mode fiber may have a diameter 120 of core 104 approximately sixty two microns (62 μm). Regardless of whether the fiber 100 is single-mode or multi-mode, the diameter 122 of the cladding 106 is typically one hundred twenty five microns (125 μm).

Coating 102 has diameter 124, a thickness 126, and surrounds cladding 106. Coating 102 is composed of absorptive material and contracts or expands depending on the amount of light that the surface is exposed to. The flexible nature of core 104 and cladding 106 cooperate with coating 102 to provide for the movement of fiber 100 when coating 102 expands and constricts.

While it is contemplated that coating 102 surrounds cladding 106 for the entire length of fiber 100, it is also to be appreciated that the entire fiber 100 need not be coated with coating 102. Instead, in an alternative embodiment, only the portion of fiber 100 which would be exposed to the converging light 200 can be coated with coating 102. For example, the coating 102 may begin at end 108 of fiber 100, and coat only a portion of the length of the fiber, such as a three millimeter (3 mm) length of fiber 100.

In a preferred embodiment, coating 102 may be made of a heat or light absorbing material which constricts when exposed to heat or light. For example, these materials may include a black, heat and light absorbing oxide or paint, and may also include metals or organic polymers having these constricting properties. In a preferred embodiment, coating 102 includes titanium nitride (TiNi). This material may be evaporatively coated onto cladding 106 of fiber 100, or fiber 100 may be dipped into the material to coat the outer surface of cladding 106. Other suitable materials for use in coating 102 include FLEXINOL, DYNALLOY, and NITINOL, which all have the constricting characteristics necessary for use within the present invention.

One method of manufacturing the fiber of the present invention includes the dipping the end portion of fiber 100 into a coating material. This would result in core 104 being covered with the coating material 102. Once coated, end 108 may be polished by any method known in the art to remove coating material 102 from end 108, thereby exposing the core 104 for receiving the incoming light 202.

Fiber 100 may also be manufactured with coating 102 being integral to cladding 106. In this alternative embodiment, fiber 100 is formed with a core 104 and a cladding 106 which has been manufactured to include a coating material 102, thus eliminating the need for an external coating 102. This coating materials is shown in FIG. 3 as particles included in the outer surface of the cladding. This fiber with an integral coating material facilitates the use of fiber 100 by eliminating any hazard of scratching the coating during the installation of the fiber 100 in optical equipment.

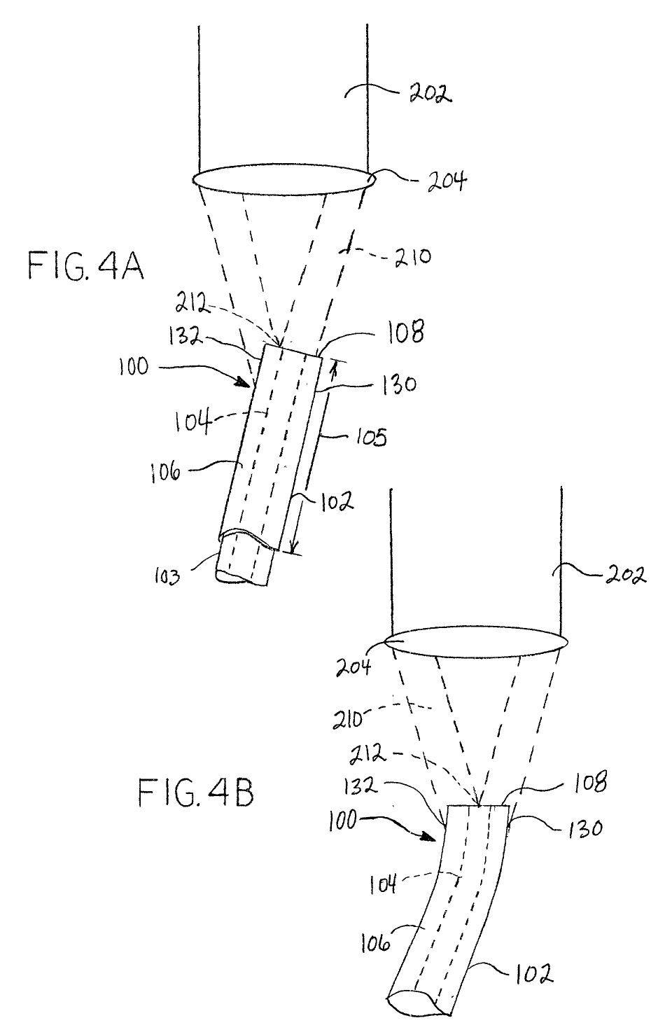

Referring to FIG. 4A, a side view of a preferred embodiment of the Passive Fiber Alignment Using Exterior Surface Absorption of the present invention shows fiber 100 improperly aligned with larger converging beam 210. Focal point 212 of larger converging beam 210 contacts fiber end 108 in the area of cladding 106, resulting in a lack of light traveling into and through core 104. Due to the misalignment of the end 108 of fiber 100 with converging beam 210, a larger amount of light strikes coating 102 on left side 132 of fiber 100, and a smaller amount of light strikes coating 102 on the right side 130 of fiber 100.

The imbalance of light between left side 132 and right side 130 of fiber 100 causes left side 132 to constrict while right side 130 begins to expand. Coating 102 will continue this process of expanding and constricting until there is an equal amount of light around fiber end 108. The process will stop when fiber 100 is in an equilibrium or balanced position where the light striking left side 132 equals the light striking right side 130. This process is best summarized as the self-alignment of the optical fiber 100 with an incoming converging light beam 200.

Referring now to FIG. 4B, a side view of the preferred embodiment of the Passive Fiber Alignment Using Exterior Surface Absorption of the present invention showing the adjustment of fiber 100 to a proper, balanced position where the larger converging beam 210 focuses on core 104 of fiber 100. As shown, in response to the imbalanced light striking coating 102 on the left side 132 and right side 130 of fiber 100, the end 108 of fiber 100 has adjusted its position to equalize the light striking sides 130 and 132. This adjusted position places the location of the core 104 on end 108 so that the focal point 212 of the converging beam 210 will now contact core 104 at fiber end 108.

The bending of fiber 100 to position the core 104 at focal point 212 is caused by the constricting of coating 102 on the left side 132 of fiber 100, and the expanding of the coating 102 on right side 130. In the new, adjusted position, the light from converging beam 210 is balanced on sides 130 and 132 which produces an equal amount of constriction of coating 102 on the left side 132 and right side 130. This equilibrium, or stabilized position, places core 104 of fiber 100 in its optimal position to allow converging light 210 to strike core 104 and enter fiber 100.

FIG. 4A also shows that only a length of fiber 100 need be coated with coating 102. Specifically, coating 102 is shown covering only a portion of cladding 106, with exposed cladding (designated 103) depicting an un-coated portion of fiber 102. The length 105 of the coated portion may vary depending on the application, including the magnitude of positional correction necessary, and the architecture of the optical component.

While the coating discussed herein is described as a coating on an optical fiber, it is to be appreciated that the absorptive material may be coated on the exterior surface of the fiber. Alternatively, the absorptive material may be impregnated into the fiber cladding (as shown in FIG. 3), or into an exterior surface of the fiber itself. As yet another alternative, the absorptive material may be added to the exterior surface of, or coated on, the buffer sleeve (not shown) in order to properly position the fiber contained within the sleeve.

For clarity of the discussion, the present invention has been discussed in conjunction with a converging light beam striking the left side 132 and right side 130 of fiber 100. However, it is to be appreciated that the present invention operates to adjust the end 108 of fiber 100 in three dimensions, thereby providing a solution to problems in optical systems where an optical fiber must be aligned with an incoming light source, such as converging light beam 210.

While the methods and apparatus for the passive fiber alignment of the present invention as herein shown and disclosed in detail is fully capable of obtaining the objects and providing the advantages herein before stated, it is to be understood that it is merely illustrative of preferred embodiments of the invention and that no limitations are intended to the details of the method, construction or design herein shown other than as described in the appended claims.

I claim:

1. An optical fiber for receiving a converging light beam, comprising:
a flexible body having a cylindrical core extending axially through a cladding, said body having an end and an outside surface; and
a coating on said outside surface of said body and responsive to exposure to light wherein said coating constricts when exposed to light to position said end of said flexible body within said converging light beam.

2. The optical fiber of claim 1, wherein said coating comprises an organic polymer.

3. The optical fiber of claim 1, wherein said coating comprises a metal.

4. The optical fiber of claim 1, wherein said coating comprises a heat-absorbing film.

5. The optical fiber of claim 1, wherein said coating comprises titanium nitride.

6. The optical fiber of claim 1, wherein said coating comprises nitinol.

7. The optical fiber of claim 1, wherein said coating comprises flexinol.

8. An optical fiber for receiving a converging light beam, comprising:
a flexible cylindrical core having an end; and
a flexible cladding including a material responsive to exposure to light wherein said material constricts when exposed to light to position said end of said flexible cylindrical core within said converging light beam.

9. The optical fiber of claim 1, wherein said material comprises an organic polymer.

10. The optical fiber of claim 1, wherein said material comprises a metal.

11. The optical fiber of claim 1, wherein said material comprises a heat-absorbing film.

12. The optical fiber of claim 1, wherein said material comprises titanium nitride.

13. The optical fiber of claim 1, wherein said material comprises nitinol.

14. The optical fiber of claim 1, wherein said material comprises flexinol.

15. A method of aligning an optical fiber having an outer surface and a flexible cylindrical core having an end with an incoming converging light beam, comprising the steps of:
coating said outer surface of said optical fiber with a material responsive to exposure to light wherein said material constricts when exposed to light; and
positioning said optical fiber in a light beam wherein said coating receiving light from said light beam constricts to position said end of said flexible cylindrical core within said light beam.

16. The method of aligning an optical fiber of claim 15, wherein said light beam is a converging light beam.

17. The method of aligning an optical fiber of claim 15, wherein said light beam is a diverging light beam.

18. The method of aligning an optical fiber of claim 15, wherein said light beam is a collimated light beam.

19. The method of aligning an optical fiber of claim 15, wherein said material comprises titanium nitride.

20. A method of manufacturing a self-aligning optical fiber, comprising the steps of:
providing an optical fiber having an end, an outside surface and a core; and
coating a portion of said outside surface with a material responsive to exposure to light wherein said material constricts when exposed to light.

21. The method of manufacturing a self-aligning optical fiber of claim 20, wherein said coating a portion of said outside surface comprises dipping said optical fiber into said material.

22. The method of manufacturing a self-aligning optical fiber of claim 20, further comprises:
dipping said optical fiber into said material; and
polishing said end.

23. A method of manufacturing a self-aligning optical fiber, comprising the steps of:
providing an optical fiber having an outside surface and a core; and
impregnating a portion of said outside surface with a material responsive to exposure to light wherein said material constricts when exposed to light.
